(19) United States
(12) Patent Application Publication
(10) Pub. No.: US 2016/0370991 A1
(43) Pub. Date: Dec. 22, 2016

(54) KEYBOARD INTERFACE APPLICATION

(71) Applicant: Yair ITZHAIK, Nahariya (IL)

(72) Inventor: Yair ITZHAIK, Nahariya (IL)

(21) Appl. No.: 14/902,099

(22) PCT Filed: Jul. 1, 2014
(86) PCT No.: PCT/IL2014/050588

§ 371 Date: Dec. 30, 2015

Related U.S. Application Data
(60) Provisional application No. 61/841,514, filed on Jul. 1, 2013.

(51) Int. Cl. G06F 3/0488; G06F 17/22; G06F 17/27

(52) U.S. Cl. CPC G06F 3/04886; G06F 17/275; G06F 17/2217

(57) ABSTRACT

A method for usage of a keyboard interface with less number of keys than characters in a language is provided herein. The method includes the following steps: displaying a keyboard of a given language, wherein, characters of the given language are assigned to keys on the keyboard, wherein for at least one key: (i) a primary character is determined as a carrier character (CC) and one or more predefined characters are determined as accompanied characters (AC); (ii) one or more AC are assigned to the same key with one CC wherein each CC display characteristics is distinctive from the AC display characteristics; receiving a first sequence of keystrokes followed by a second sequence of keystrokes from one or more keys on the keyboard interface which relate to the same word; checking the first sequence of keystrokes from the one or more keys to determine if it was received from keys that were keystroked consecutively more than one time and are assigned with CC and assigned with one or more AC; analyzing the one or more keystrokes in first the sequence that were typed on keys with CC and one or more AC to decode each sequence that was received from the same key to a valid sequence in the given language.

### CROSS REFERENCE TO RELATED APPLICATION

This application is a national stage entry of PCT/IL2014/050588 filed Jul. 1, 2014, under the International Convention claiming priority over U.S. Provisional application No. 61/841,514 filed Jul. 1, 2013.

### TECHNICAL FIELD

The present invention relates to the field of computerized devices' interface, and more particularly, to an application that is implementing a reduced keyboard interface.

### SUMMARY OF INVENTION THE INVENTION

According to some embodiments of the invention, a method for usage of a keyboard interface with less number of keys than characters in a language is provided herein. The method comprises the following steps: (a) displaying a keyboard of a given language, wherein, characters of the given language are assigned to keys on the keyboard, wherein for at least one key: (i) a primary character is determined as a carrier character (CC) and one or more predefined characters are determined as accompanied characters (AC); (ii) one or more AC are associated to the same key with one CC wherein each CC display characteristics is distinctive from the AC display characteristics, (b) receiving a first sequence of keystrokes followed by a second sequence of keystrokes from one or more keys on the keyboard interface which relate to the same word; (c) checking the first sequence of keystrokes from the one or more keys to determine if it was received from keys that were keystroked consecutively more than one time and are associated with CC and associated with one or more AC; (d) analyzing the one or more keystrokes in the first sequence that were typed on keys with CC and one or more AC to decode each sequence that was received from the same key to a valid sequence in the given language, wherein said analyzing comprising the following steps: (a) identifying the amount of keystrokes in the received first sequence, (b) determining a first sequence of characters, wherein when first the received sequence includes at least two consecutive CC it is decoded according to predefined and calculated rules based on statistical analytics of the given language of words usage, wherein a first sequence of characters is replaced to a second sequence of characters based on analysis of the received second sequence of keystrokes, according to the context of the first sequence in the word, and according to an algorithm of identifying and replacing CCs in the given language, and wherein the assignment of the CC and AC on the keyboard interface is arranged to minimize options of multiple yielded characters or a series of characters ambiguity.

According to some embodiments of the invention, the predefined rules are related to order of arrangement of the characters on the keyboard.

According to some embodiments of the invention, at least one key is assigned with one character.

According to some embodiments of the invention, the predefined rules are related to identified rules of the given language.

According to some embodiments of the invention, the predefined rules are determined according to characters in the selected language and statistical analysis of words in a database of words in the language.

According to some embodiments of the invention, the order of arrangement is determined by the following steps: (a) searching words with double appearance of same character in the database of words; (b) counting for each character in the language the number of words that were found; (c) selecting a predefined amount of characters with a number of words equal or lower to a predefined threshold; (d) defining the selected characters as primary characters; (e) marking the primary characters as carrier characters;

assigning the CC to keys on the keyboard; (f) searching for each character that was not marked as CC, words that include the character; (g) counting for each character in the language the number of words that were found; (h) selecting a predefined amount of characters with a number of words equal or lower to a predefined threshold; (i) defining the selected characters with low frequency in words in the language as accompanied characters; (j) marking the accompanied characters; (k) assigning the AC as subsidiary characters to keys with CC of first type; and (l) assigning characters that were not marked as AC or CC to keys with a single character.

According to some embodiments of the invention, the statistical analysis of words in the database of words in the language includes searching for common predefined sequence of characters and determining the location of the characters of the predefined sequence close to each other on the keyboard.

According to some embodiments of the invention, determining the sequence of characters to be at least one of: (i) prefix; (ii) infix; and (iii) suffix, of a word and wherein according to the determining a predefined rule is applied.

According to some embodiments of the invention, a simulation of keystroking of a predefined amount of words in the language is performed to calculate and assign AC to CC to yield minimal number of keystrokes of the predefined amount of words.

According to some embodiments of the invention, calculating for each character the amount of words it appears in the language and selecting the characters which are above a predefined threshold to be located at the peripheral keys on the keyboard.

According to some embodiments of the invention, a predefined key on the keyboard enables selection of actions or enables selection of other keys.

According to some embodiments of the invention, the assigning of the AC as subsidiary characters to keys with CC that is based on a prefix, assists in decoding the received sequence.

According to some embodiments of the invention, AC are assigned with CC based on data related to frequency of usage of words in the language, where AC and CC appear, trying to minimize the number of potential collisions which happen when one legal word in the language that has double appearance of CC, when this double appearance of CC is replaced to the related AC, it yields to another legal word in the language, and in case of a collision between a sequence of CC and AC the most common word with one of the sequences is presented in the first place for to the user, and the second word is presented as a second option.

According to some embodiments of the invention, AC are assigned with CC such that existing algorithms for auto completion of words are used.

According to some embodiments of the invention, AC are assigned with CC such that multiple keystrokes ambiguity is minimal.

According to some embodiments of the invention, a sequence of keystrokes is entered in an equal pace.

According to some embodiments of the invention the selection between two types of CC on the keyboard is determined based user behavior. According to some embodiments of the invention t the selection between two types of CC on the keyboard is determined based user behavior including at least one of: duration of the keystroke, a gesture of the fingers, identifying different fingers on the keyboard interface, or a gesture captured by a camera.

According to some embodiments of the invention the AC are assigned with CC such that, minimum ambiguity sequences having valid words in a given language for both sequence of consecutive Carrier characters and replacing corresponding consecutive AC letters.

The present invention discloses a system for usage of a keyboard interface with less number of keys than characters in a language. The system comprised of: a keyboard of a given language, wherein, characters of the given language are assigned to keys on the keyboard, wherein for at least one key: (i) a primary character is determined as a carrier character (CC) and one or more predefined characters are determined as accompanied characters (AC); (ii) one or more AC are assigned to the same key with one CC wherein each CC display characteristics is distinctive from the AC display characteristics, a display module for receiving a first sequence of keystrokes followed by a second sequence of keystrokes from one or more keys on the keyboard interface which relate to the same word and input analysis module for checking the first sequence of keystrokes from the one or more keys to determine if it was received from keys that were keystroked consecutively more than one time and are associated with CC and associated with one or more AC, analyzing the one or more keystrokes in first the sequence that were typed on keys with CC and one or more AC to decode each sequence that was received from the same key to a valid sequence in the given language, where said analyzing comprising the following steps:

identifying the amount of keystrokes in the received first sequence,

determining a first sequence of characters,

According to some embodiments of the invention t when first the received sequence includes at least two consecutive CC it is decoded according to predefined and calculated rules based on statistical analytics of the given language of words usage, According to some embodiments of the invention t a first sequence of characters is replaced to a second sequence of characters based on analysis of the received second sequence of keystrokes, according to the context of the first sequence in the word, and according to an algorithm of identifying and replacing CCs in the given language, and According to some embodiments of the invention t the assignment of the CC and AC on the keyboard interface is arranged to minimize options of multiple yielded characters or a series of characters ambiguity.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

FIGS. 1A-1C illustrate various keyboard interfaces, according to some embodiments of the invention;

FIG. 2 is a block diagram illustrating modules of keyboard interface application, according to some embodiments of the invention;

FIG. 3 is a flowchart illustrating activity display module, according to some embodiments of the invention;

FIG. 4 is a flowchart illustrating activity of analysis module, according to some embodiments of the invention;

FIGS. 5A-5B is a flowchart illustrating activity of keyboard construction module, according to some embodiments of the invention; and

FIG. 6 is a flowchart illustrating activity of ambiguity solution module, according to some embodiments of the invention.

### DETAILED DESCRIPTION OF THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

The term “computerized mobile device” as used herein in this application, is defined as a mobile device with capability of running applications as well as streaming multimedia data to a screen that is external to the computerized mobile device (e.g. a mobile phone or a tablet device).

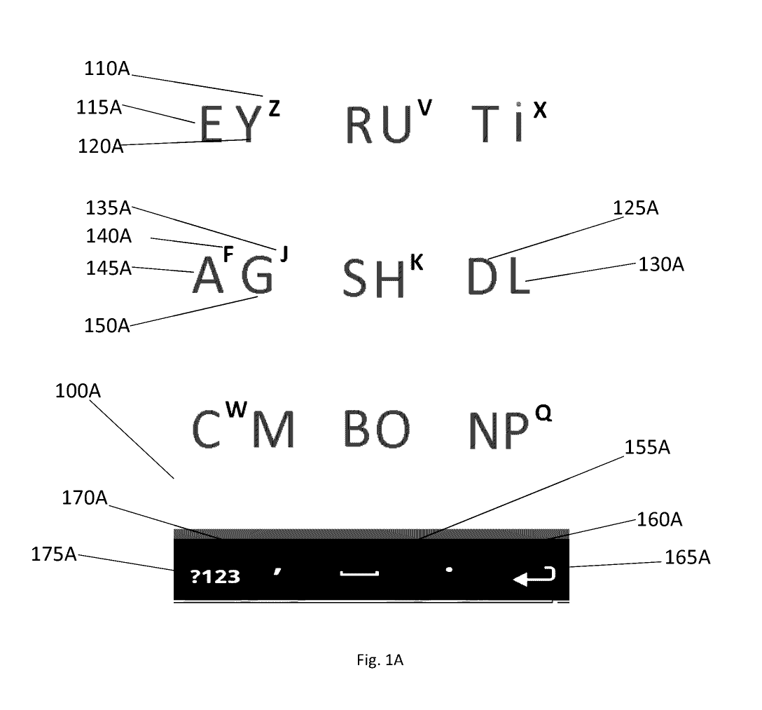

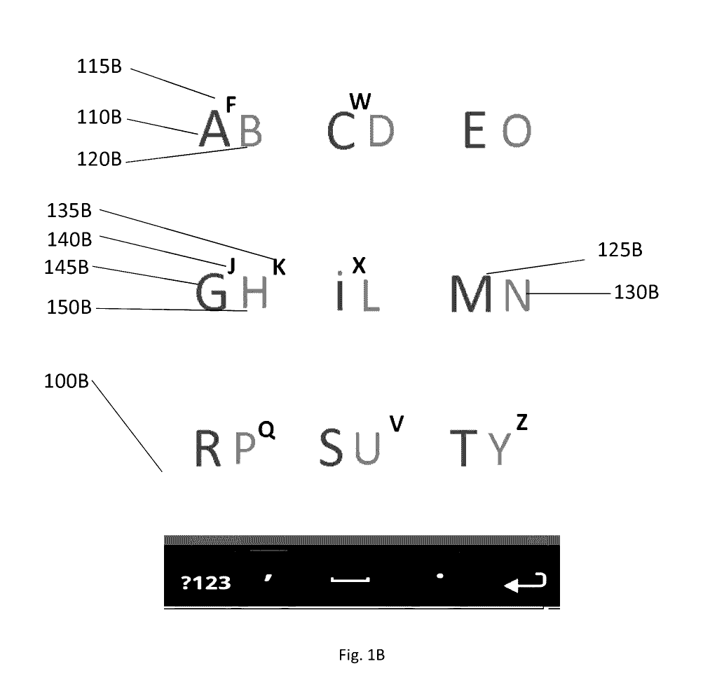

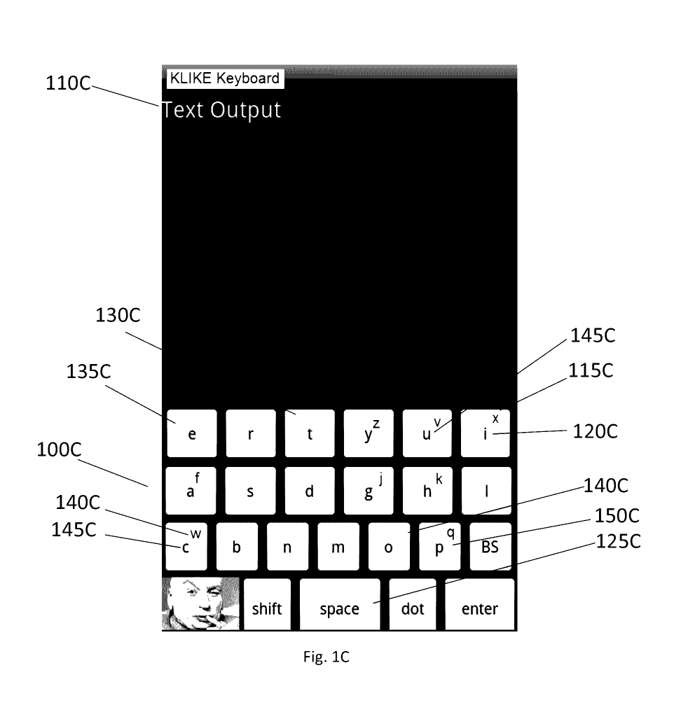

FIGS. 1A-1C illustrate various keyboard interfaces, according to some embodiments of the invention.

FIG. 1A illustrates in a non limiting example a calculated arrangement of Latin characters on a keyboard interface 100A. According to some embodiments of the invention, the display of the keyboard interface is of a given language, in a non limiting example, the given language is English.

According to some embodiments of the invention, characters of the given language are assigned to keys on the keyboard. On at least one key on the keyboard 100A a primary character may be determined as a carrier character (CC). In a non limiting example, ‘y’ 120A, ‘A’ 145A and ‘g’ 150A.

According to some embodiments of the invention, one or more predefined characters are determined as accompanied characters (AC). In a non limiting example, ‘z’ 110A, ‘F’ 140A.

According to some embodiments of the invention, one or more AC are assigned to the same key with one CC, wherein each CC display's characteristics is distinctive from the AC display characteristics.

According to some embodiments of the invention, there may be two or more characters on a key. In a non limiting example, ‘D’ 125A and ‘L’ 130A where ‘D’ 125A is CC and ‘L’ 130A is also a CC that both are not accompanied with AC letters. In this non limiting example, the characters are arranged in a horizontal sequence, but they may be presented on any adjacent directions (i.e. one over the other, in diagonal manner or half overlapping.

According to some embodiments of the invention, there may be various types of keystroking. The various types may distinguish between typing on the same key to produce one of the chosen characters and between multiple instances of the primary character on the key. Upon one type of keystroke the left primary character ‘D’ 125A may be displayed on a screen, i.e. may be received as input for later processing and upon a second type of keystroke which is in this example character ‘L’ may be interpreted by the keyboard interface as the input.

According to some embodiments of the invention, there may be three characters on a key. In a non limiting example, ‘E’ 115A, ‘Y’ 120A and ‘z’ 110A where ‘E’ 115A and ‘Y’ 120A are the primary keys (i.e. CC) and ‘z’ 110A are the accompanied characters (AC). Upon one keystroke the primary character ‘E’ 115A or ‘Y’ 120A may be displayed on a screen, i.e. may be received as an input by the keyboard interface. The choice between ‘E’ 115A and ‘Y’ 120A is according to the type of the keystroking (long and short keystroke, etc.).

According to some embodiments of the invention, upon two keystrokes on the key with ‘E’ 115A, ‘Y’ 120A and ‘z’ 110A, if they are of the same type of keystroking related to ‘E’ 115A, a double ‘E’ 115A ‘EE’ is interpreted as the input, otherwise if they are of the same type of keystroking related to ‘Y’ 120A the double ‘Y’ 110A ‘YY’ is interpreted or the accompanied character ‘z’ 110A may be interpreted by the keyboard interface as the input. If the double keystroke is of two different types of keystroking, then the input can be interpreted as ‘EY’ or ‘YE’.

According to some embodiments of the invention, upon three keystrokes on the key with ‘E’ 115A, ‘Y’ 120A and ‘z’ 110A with the type that activates ‘Y’ may be interpreted by the keyboard interface as ‘Yz’ as the input. Alternatively, it may be interpreted as the sequence ‘zY’ ‘EY’ or ‘YE’.

According to some embodiments of the invention, upon one keystroke on the key with ‘A’ 145A, ‘F’ 140A, ‘G’ 150A and ‘J’ 135A the keyboard interface may interpret it as ‘A’, or ‘G’ according to the type of the keystroking.

According to some embodiments of the invention, upon two keystrokes on the key with ‘A’ 145A, ‘F’ 140A, ‘G’ 150A and ‘J’ 135A the keyboard if they are of the type of keystroking that is related to ‘A’ 145A, the interface may interpret it as ‘F’ or ‘AA’. If the type of keystroking is related to ‘G’ 150A, the interface may interpret it as ‘J’ or ‘GG’.

According to some embodiments of the invention, upon three keystrokes on the key with ‘A’ 145A, ‘F’ 140A, ‘G’ 150A and ‘J’ 135A the keyboard interface may interpret it as ‘AAA’ or ‘GGG’, or any consecutive combination of letters ‘A’, ‘A’, ‘G’ or any consecutive combination of letters ‘A’, ‘G’, ‘G’, or ‘AF’ or ‘FA’ or ‘GF’, or ‘FG’ or ‘GJ’ or ‘JG’, or ‘AJ’ or ‘JA’.

According to some embodiments of the invention, upon four keystrokes on the key with ‘A’ 145A, ‘F’ 140A, ‘G’ 150A and ‘J’ 135A the keyboard interface, as the case in previous examples, has two levels of interpretation: The first will decide if the basic input letter is ‘A’ or ‘G’, according to the type of the keystroking, then the second level will decide if any two consecutive CC letters (‘AA’ or ‘GG’) is interpreted as one ‘F’ or ‘J’.

As in ‘E’ 135C there can be CC letters that have no accompanied AC letters.

FIG. 1B illustrates another calculated arrangement of Latin characters on a keyboard 100B. According to some embodiments of the invention, the display of the keyboard is of a given language.

According to some embodiments of the invention, the primary character may be in a different color and different size than the accompanied characters.

I n a non limiting example, in the key with ‘A’ 110B, ‘F’ 115B and ‘B’ 120B the CC are ‘A’ 110B and ‘B’ 120B and the AC is ‘F’ 115B. ‘A’ 110B may be larger than the AC and one of the CC may be in different color (and sometimes size) such as ‘B’ 120B or different size such as ‘F’ 115B.

FIG. 1C illustrates another order of arrangement of Latin characters on a keyboard 100C.

According to some embodiments of the invention, some of the keys on the keyboard interface may be assigned with one character. In a non limiting example, in order to write ‘Text Output’ 110C a user may press on the following keys: one keystroke for ‘T’ 130C one keystroke for ‘e’ 135C two keystrokes for ‘x’ 115C one keystroke for ‘t’ 130C ‘space one keystroke for ‘o’ 140C one keystroke for ‘u’ 145C one keystroke for ‘t’ 130C one keystroke for ‘p’ 150C one keystroke for ‘u’ 145C one keystroke for ‘t’ 130C.

According to some embodiments of the invention, the keyboard interface 100A-100C may be implemented on a computerized mobile device, a remote control, gesture of a camera and the like.

According to some embodiments of the invention, the keyboard interface may have virtual as well as physical key.

According to some embodiments of the invention, selection between the two types of the CC letters s on the keyboard may be implemented in several ways based on user behavior. One way is by identifying a long or a short keystroke on a touch screen. Another way is by identifying a gesture such as swiping a finger swiftly from the key. Alternatively, by identifying usage of a device which recognizes fingers and enabling the user to type with different fingers on the keyboard interface. Another way is to use the multi-touch effect. For example, to identify clicking with two fingers in the same time, or only with one finger. Another option is by identifying predefined gesture captured by camera.

According to some embodiments of the invention, the keyboard interface may be implemented as a kinetic keyboard. A user may type in the air in a non limiting example, by pointing with her or his fingers on the right direction to the letter the user wants to type, i.e. there is no physical keyboard and no need for physical pad on which a virtual keyboard is being displayed (but in some versions it may use such pad).

According to some embodiments of the invention, there may be any type of keyboard displayed on a screen. A camera may capture the movement of the user's fingers to be interpreted. The camera may follow the moving fingers of the user. The camera may start following the fingers from two endpoints. The camera may follow the fingers movement from the endpoints to the next key is based on the direction of vector and the size of the movement that the finger performs. The user may see the results of the fingers' movement on the keyboard and thus typing confidentially. After the movement to the key with the relevant character to the user, the user may perform an additional gesture. In a non limiting example, the additional gesture may be moving the user's first forward to click or using the swipe method in which the finger does not leave the touch screen.

Moreover, the camera may distinguish between the fingers of the left and the fingers of right hands and may interoperate them in a different manner even if they point to the same target or direction or area on the screen. Additionally, the user may speak the words which are being typed and it may be recorded and interpreted as well, or/and cross-matched with the interpreted keying sequence to raise the probability of a right overall interpretation.

According to some embodiments of the invention, the keyboard interface may enable a user to add one or more personal keys with personal symbols to the keyboard interface.

According to some embodiments of the invention the keyboard screen may partly transparent enabling to see the display located behind the keyboard.

According to some embodiments of the invention, it is suggested to provide two arrays of keyboard next to each other, enabling to type with both hands each hand is associated with one keyboard array.

According to some embodiments of the invention, the keyboard interface may allow navigation on the device to perform various functions. For example, typing on ‘ACE’ and on the character ‘s’ may perform a search and the typed text may be the searching words. In another non limiting example typing on ‘T’ and ‘ACE’ may provide a translation.

According to some embodiments of the invention, there is an option to add a fixed or mobile physical indicator on the computer device or on a cover of the device such that the location of the indicator may point the position of the line on the screen to the fingers. This indication of the fingers, for example, from both sides of the screen. May enable a user after a short training to quickly type on the screen with one finger or two fingers.

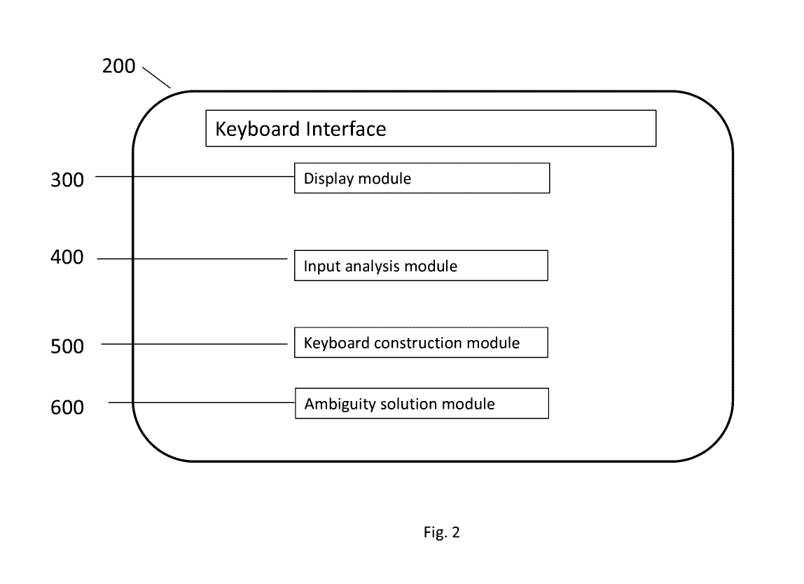

FIG. 2 is a block diagram illustrating modules of keyboard interface application 200, according to some embodiments of the invention.

According to some embodiments of the invention, keyboard interface application 200 may be comprised of display module 300, analysis module 400, keyboard construction module 500 and ambiguity module 600.

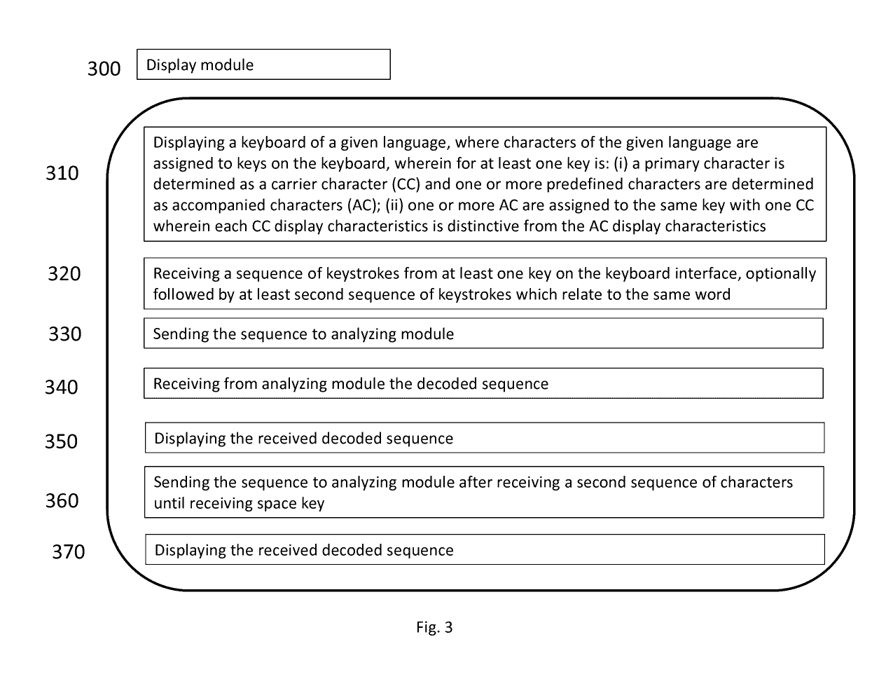

FIG. 3 is a flowchart illustrating activity of display module 300, according to some embodiments of the invention.

According to some embodiments of the invention, display module 300 may display a keyboard of a given language, where characters of the given language are assigned to keys on the keyboard, wherein for at least one key is: (i) a primary character is determined as a carrier character (CC) and one or more predefined characters are determined as accompanied characters (AC); (ii) one or more AC are assigned to the same key with one CC wherein each CC display characteristics is distinctive from the AC display characteristics (stage 310). (iii) One or more CC (with or without accompanied AC) are displayed adjacent on the keyboard, and are distinctive from each other by their type of keying—for example, long or short keystroke, multi-touch effect, gestures and more).

According to some embodiments of the invention, when a user types on the keyboard display module 300 receives a first sequence of keystrokes from one or more keys on the keyboard interface followed by at least second sequence of keystrokes related to same word (stage 320). The display module 300 may send the first sequence to analysis module 400 to decode the sequence that was sent (stage 330). In a non limiting example, the sequence ‘CC’ may be decoded after the user typed twice on ‘CC’ 145A in FIG. 1C and sent from analysis module 400 to display module 300 (stage 340).

According to some embodiments of the invention, display module 300 may display the received decoded sequence with two consecutive ‘CC’ (stage 350), with the AC letter instead.

AC letter can be an alphanumeric symbol or any other symbol.

According to some embodiments of the invention, after the user types ‘cc’ as first sequence and then a second sequence of characters which is the suffix or the beginning of the suffix of the word, in a non limiting example, ‘ild’ the first sequence ‘cc’ (of two consecutive ‘CC’) and the second sequence ‘ild’ are sent to analysis module as one sequence (stage 360). Alternatively, if the sequence of two consecutive ‘CC’ is typed as the prefix of a word it will be replaced regardless of the next character that is typed or the whole suffix since in the given language there are no words which start with ‘cc’. In another example, in case the sequence ‘cc’ is typed after the character ‘a’ then sometimes only the next characters of the word are needed to decide, for example the next letter ‘u’ can determine that the word should begin with ‘accu’ as in the word ‘accumulate’ or next letter ‘a’ can determine that the word should begin with ‘awa’ as in the word ‘aware’, or the whole suffix is needed as in the words ‘access’ because if instead the last ‘s’ the sequence includes ‘t’ then the word will begin with ‘awest’ as in the word ‘awestruck’.

According to some embodiments of the invention, analysis module 400 may analyze the second sequence and send back to display module the following sequence instead ‘wild’ so display module may display the received decoded sequence ‘wild’ instead of the sequence of two consecutive ‘CC’ that was previously displayed (stage 370).

According to some embodiments of the invention, when there is a sequence of three consecutive keystrokes of CC as in the sequence ‘iii’, where ‘i’ is CC letter and ‘x’ is its AC letter, the analysis module 400 may analyze to decide if the ‘iii’ sequence is ‘ix’ as in the word ‘mix’ or ‘xi’ as in the word or ‘axis’.

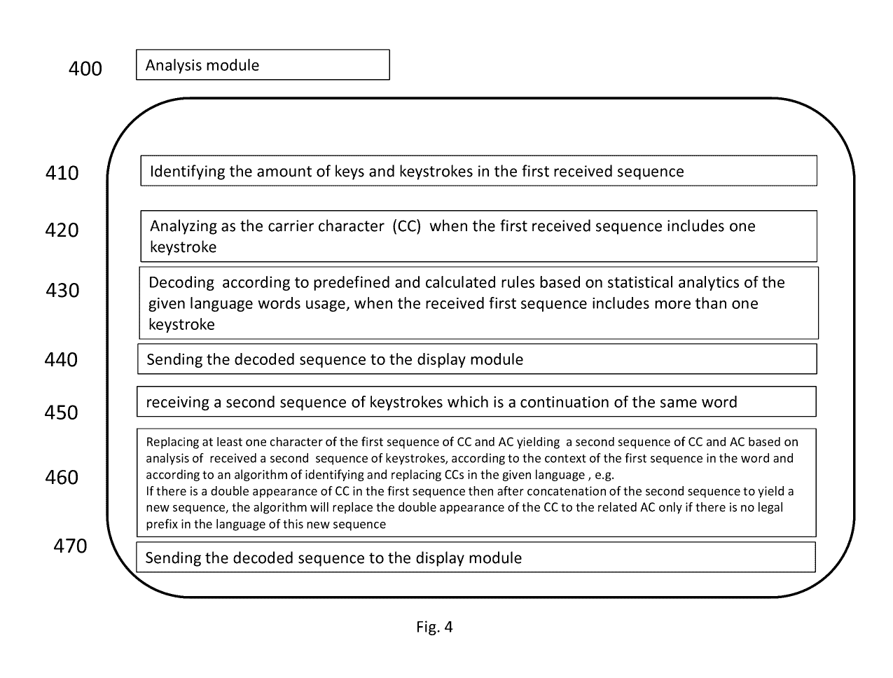

FIG. 4 is a flowchart illustrating activity of analysis module 400, according to some embodiments of the invention.

According to some embodiments of the invention, analysis module 400 may identify the amount of keys and keystrokes in the received sequence (stage 410).

According to some embodiments of the invention, when the received sequence includes one keystroke, analysis module 400 may analyze it as the carrier character (CC) or the character that is on the key in case there is only one character (stage 420).

According to some embodiments of the invention, the analysis module 400 may decode according to predefined and calculated rules based on statistical analytics of the given language words usage, when the received a first sequence includes more than one keystroke (stage 430).

According to some embodiments of the invention, the decoded sequence is sent to the display module 300 (stage 440).

According to some embodiments of the invention, after receiving a second sequence which is a continuation of the same word (stage 450), replacing at least sequence of two consecutive CC to AC yields a new prefix to be analyzed together with the second sequence that can include more sequences of two consecutive letters of CC (same CC or other one). The analysis is performed based on analyzing the received second sequence of keystrokes, according to the context of the new prefix in the word and according to an algorithm of identifying replacing CCs in ACs (stage 460) and then sending the decoded sequence to the display module (stage 470). For example, e.g. if there is a double appearance of CC in the first sequence then after concatenation of the second sequence to yield a new sequence, the algorithm will replace the double appearance of the CC to the related AC only if there is no legal prefix in the language of this new sequence

According to some embodiments of the invention, analysis module 400 may have various implementations.

According to one option of implementation the decoding of a sequence as described in stage 430 may be performed only at the end of a word.

According to another implementation an algorithm may take into consideration a prefix of a word when a sequence is decoded. The algorithm may be customized for each keyboard interface according to the given language.

According to another implementation a set of words in the given language may be generated such that in each word there are characters with multiple appearance of CC or multiple AC which are on the same key on the keyboard interface. For example, in keyboard interface 100A in FIG. 1A upon two keystrokes of ‘g’ 150A the accompanied character ‘j’ 135A may be interpreted as the input or double ‘gg’ may be interpreted by the keyboard interface. So, for example, when a user types the word ‘agg’ it may also be interpreted as ‘aj’. An algorithm may select between the two options.

According to another implementation an algorithm may provide based on analytical statistics a prediction of a word based on its prefix. In case there is more than one option the application may offer the user the options otherwise it may select the prediction as the word that was typed.

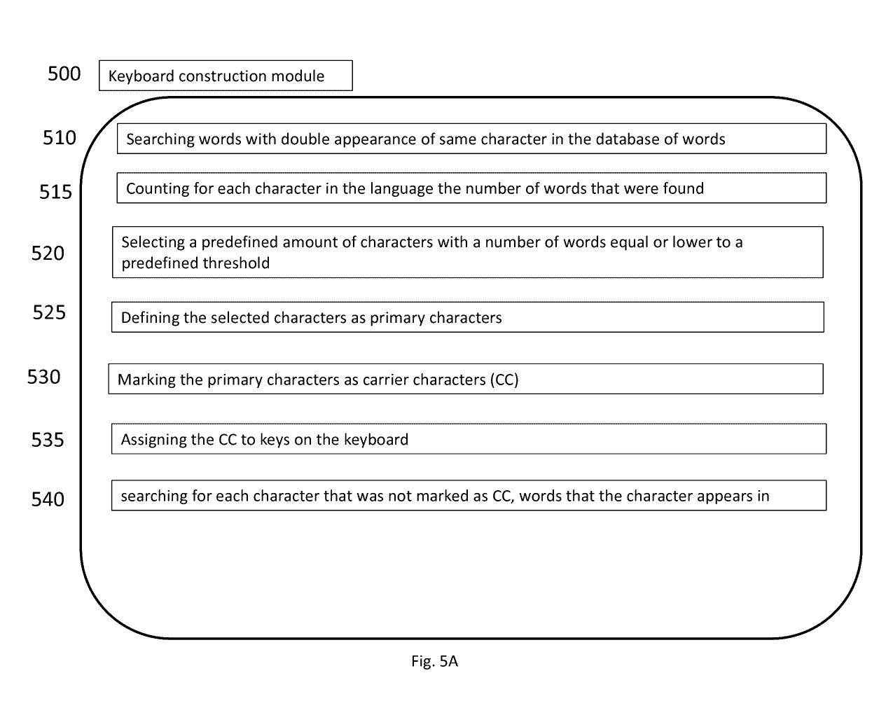

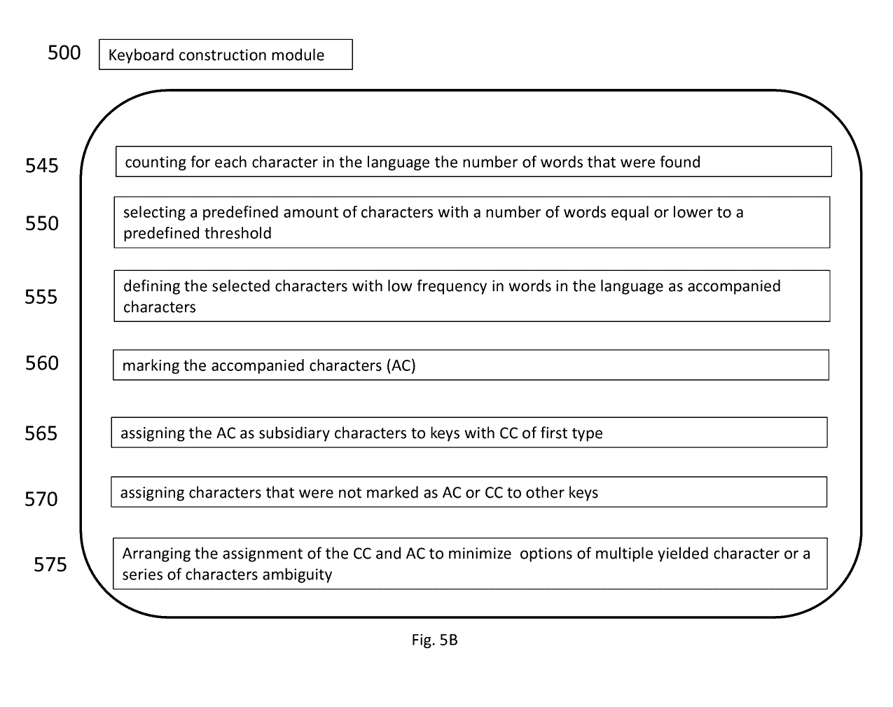

FIGS. 5A-5B represent a flowchart illustrating activity of keyboard construction module 500, according to some embodiments of the invention.

According to some embodiments of the invention, keyboard construction module 500 may search words with double appearance of same character in the database of words (stage 510).

According to some embodiments of the invention, keyboard construction module 500 may count for each character in the language the number of words that were found (stage 515).

According to some embodiments of the invention, a predefined amount of characters with a number of words equal or lower to a predefined threshold may be selected (stage 520) the selected characters may be defined as primary characters (stage 525) and marked as carrier characters (CC) (stage 530).

According to some embodiments of the invention, the CC may be assigned as such to keys on the keyboard (stage 535). Meaning, that when a user types once on a key with CC it may be interpreted as the CC.

According to some embodiments of the invention, for each character that was not marked as CC, searching for words that the character appears in (stage 540).

After counting for each character in the language the number of words that were found (stage 545) selecting a predefined amount of characters with a number of words equal or lower to a predefined threshold (stage 550).

According to some embodiments of the invention, defining the selected characters with low frequency in words in the language as accompanied characters (AC) (stage 555) and marking them as AC (stage 560).

According to some embodiments of the invention, the AC are assigned as subsidiary characters to keys with CC of first type (stage 565) and characters that were not marked as AC or CC are assigned to other keys on the keyboard these are CC that no AC are assigned to them (stage 570).

Where for most legal words in the language that have consecutive double appearance of letters of CC, replacing the two letters of same CC with the correspondent AC leads to illegal word in the language, then in case that the replacement of double CC with AC results a legal word, there is a collision(ambiguity) and there and its not clear what word the user meant to write. According to one option the system will present the user both words but first the more frequent one or the one that fit the sentence context, and then show the second word ad an option.

According to some embodiments of the invention, the assignment of the CC and AC is arranged to minimize options of multiple yielded character or a series of characters ambiguity (stage 575).

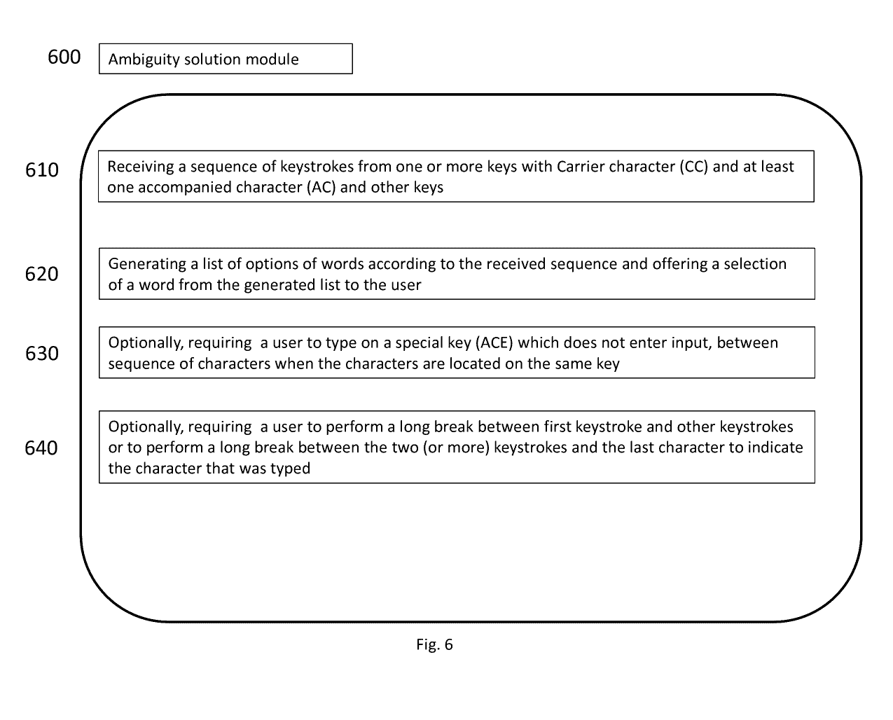

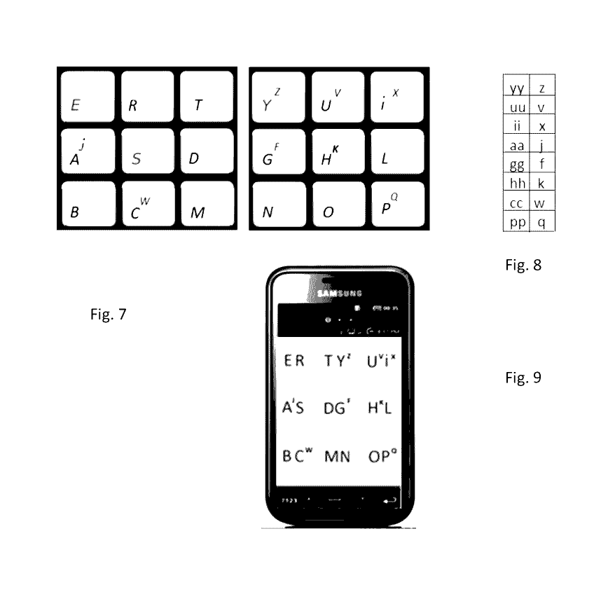

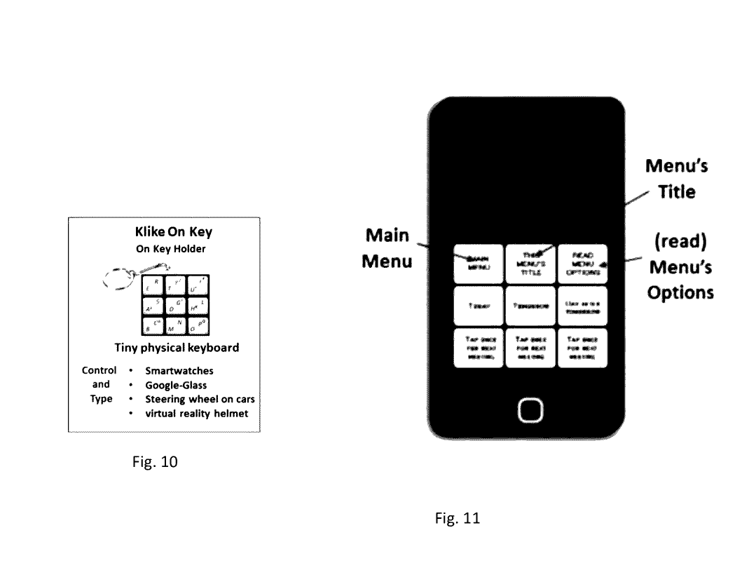

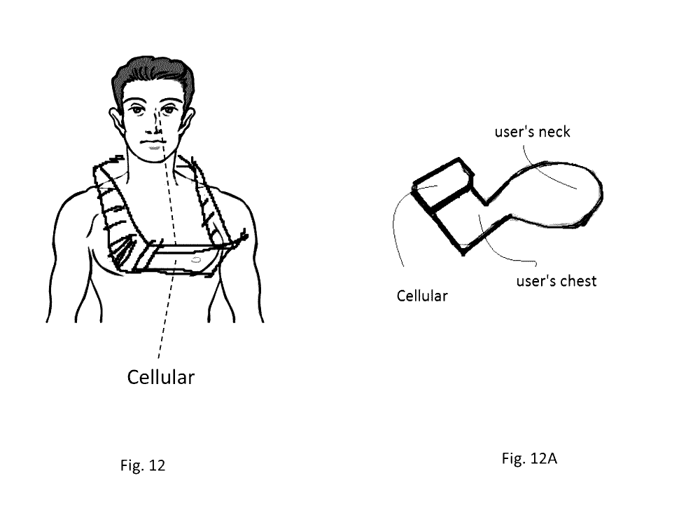

FIG. 6 is a flowchart illustrating activity of ambiguity solution module 600, according to some embodiments of the invention. Ambiguity module solution 600 is responsible for determining a sequence when multiple options are valid in the given language.

According to some embodiments of the invention, ambiguity solution module 600 may receive a sequence of keystrokes from one or more keys with consecutive Carrier characters (CC) that have suffix that present a valid word in the language and at the same time, replacing the double appearance of the CC letters to one AC letter yields also to a valid word in the language. The algorithm that is being implemented combined with the calculated arrangement of characters of CC and AC lowers the possibility of such ambiguity to minimum (between one per mill and one per million). (stage 610).

According to some embodiments of the invention, a list of options of words may be generated according to the received sequence and a selection of a word from the generated list may be offered to the user (stage 620).

Optionally, a user may be required to type on a special key (ACE) which does not enter input, between sequence of characters when the characters are located on the same key (stage 630).

Optionally, a user may be required to perform a long break between first keystroke and other keystrokes or to perform a long break between the two (or more) keystrokes and the last character to indicate the character that was typed (stage 640).

According to some embodiments of the invention, a list of options may be generated specifying ways to implement the functions of keys in the cases that there are not being displayed on the screen such the keys: Backspace, Delete, PageUp, PageDown, Home, End and cursor arrows keys. For example, by pressing a special key (the ACE key) a small window will be displayed on the screen with those keys ready for usage. Another click will take action at the cursor position on the text output.

According to some embodiments of the invention, a list of options may be generated specifying how to correct text. For example, to identify the exact position of the letter to be corrected on the text output, a user's touch will increase the size of the 2-4 letters that are under or close to the touching finger so that the finger can easily and accurately point on the letter to be corrected. FIGS. 7, 8 and 9 illustrates in a non limiting example of keyboard letters arrangement for the English language according to some embodiments of the present invention.

FIG. 10 a non-limiting example a keyboard implemented as keychain which can be used to control car steering, Google glass, smart watch etc. FIG. 11 illustrate an example, an alternative keyboard layout implementation using symbols or short text for frequently used functions. According to this layout of 3×3 squares of functional keys, the user can handle a new paradigm of apps navigation or apps in-app navigation that keeps the same role of each function activated on each square of this structure. The aim of this arrangement is to ease the learning curve and usage of any application on the smartphone especially for people with limitations such as blind and visually impaired

In the example of FIG. 11, there are unique functionalities: at the first square function as navigation to the main menu, the second square to see the menu title and the third square to read the menu options.

According to some embodiments of the invention, an examination of a measure of the “overall efficiency” of a keyboard is defined in terms of functionality, speed of typing, and ease-to-use and the percentage of the corrections that statistically happened when typing sets of common words. This factor is language related and can help in fine-tuning of the calculation of the CCs and ACs sets, and the layout of the keys. Another measure is the “learning curve” for having full command on the keyboard's usage.

According to some embodiments of the invention, the keyboard interface may be used on other various devices and for various purposes. For example, the keyboard may be used on for one of the following usages: the a car steering, wearable devices such as Smart watch, smart glass such as Google Glass, Virtual Reality devices, and Augmented Reality devices, or carrier device optionally positioned on the chest. The keyword interface can be associated or attached a smartphone to it.

According to some embodiments of the invention, this carrier device is aimed for many purposes such as for handicap people that can carry the smartphone without holding it with their hands, or for professionals that work in the field and want to free their both hands and still interacts with the smartphone in front of them.

According to some embodiments of the invention, this carrier device is bent in approximately 60 degree so that the user can easily view the smartphone screen. Optionally the carrier device includes a small periscope that is connected to the Smartphone camera and change its angle to capture pictures at any desired angle.

The current invention defines methods of automatically testing and benchmarking the “overall efficiency” and the “learning curve” measures.

According to some embodiments of the invention, an indication to the next letter that is predicted to be typed is dynamically set in the process of typing by coloring this letter or making it vibrate by changing sizes or by any other possible visual way.

According to some embodiments of the invention, the keyboard interface may be used on other various devices and for various purposes. For example, the keyboard may be used on a car steering.

The reduced keyboard interface may be implemented either by software, hardware or a combination of thereof.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

Although the invention has been described in detail, nevertheless changes and modifications, which do not depart from the teachings of the present invention, will be evident to those skilled in the art. Such changes and modifications are deemed to come within the purview of the present invention and the appended claims.

1. A method for usage of a keyboard interface with less number of keys than characters in a language, the method comprising the steps of:
displaying a keyboard of a given language, wherein, the characters of the given language are assigned to the keys on the keyboard, wherein for at least one key: (i) a primary character is determined as a carrier character (CC) and one or more predefined characters are determined as accompanied characters (AC); (ii) one or more AC are assigned to the same key with one CC, wherein each CC display characteristics is distinctive from the AC display characteristics;
receiving a first sequence of keystrokes followed by a second sequence of keystrokes from one or more keys on the keyboard interface which relate to the same word;
checking the first sequence of keystrokes from the one or more keys to determine if it was received from keys that were keystroked consecutively more than one time and are associated with CC and associated with one or more AC;
analyzing the one or more keystrokes in the first sequence that were typed on keys with CC to decode each sequence that was received from the same key to a valid sequence in the given language;
wherein said analyzing comprising the following steps:
determining a first sequence of characters;
wherein when first the received sequence includes at least two consecutive CC is decoded according to predefined rules, the rules are calculated rules based on statistical analytics of the given language of words usage;
wherein a first sequence of characters is replaced to a second sequence of characters based on analysis of the received second sequence of keystrokes, according to the context of the first sequence in the word, and according to an algorithm of identifying and replacing any of the CC double appearance to the associated AC in the given language, and
wherein the assignment of the CC and AC on the keyboard interface is arranged to minimize options of multiple yielded characters or series of characters or complete words ambiguity.

2. The method of claim 1, wherein the predefined rules are related to order of arrangement of the characters on the keyboard or related to identified rules of the given language.

3. (canceled)

4. (canceled)

5. (canceled)

6. The method of claim 2, wherein the association of the CCs characters to their ACs characters and the order of arrangement is determined by the following steps:
searching words with double appearance of same character in the database of words;
counting for each character in the language the number of words that were found;
selecting a predefined amount of characters with a number of words equal or lower to a predefined threshold;
defining the selected characters as potential primary characters;
marking the primary characters as carrier characters;
assigning the CC to keys on the keyboard;
searching for each character that was not marked as CC, words that include the character;
counting for each character in the language the number of words that were found;
selecting a predefined amount of characters with a number of words equal or lower to a predefined threshold;
defining the selected characters with low frequency in words in the language as potential accompanied characters (AC);
marking the accompanied characters;
assigning the AC as subsidiary characters to keys with CC of first type; and
assigning characters that were not marked as AC or CC to keys with a single character.

7. (canceled)

8. The method of claim 1, wherein determining the sequence of characters to be at least one of: (i) prefix; (ii) infix; and (iii) suffix, of a word and wherein according to the determining a predefined rule is applied.

9. The method of claim 6, wherein a simulation of keystroking of a predefined amount of words in the language such as a public domain corpora of the language is performed to calculate and assign the chosen AC out of the potential ACs to the potential CCs such as the final assignments of the ACs characters to the CCs characters to yield minimal amount of legal words in the language that are ambiguous.

10. (canceled)

11. The method of claim 1, wherein a predefined key on the keyboard enables selection of actions or enables selection of other keys.

12. (canceled)

13. The method of claim 1, wherein AC are assigned with CC based on data related to frequency of usage of words in the language, in case of a collision where the change in one legal word which contains at least two successive keystrokes of the same CC letter, by replacing the two successive keystrokes with the respective AC results a second legal word, the most common word out of the two words is presented first to the user, and the second word is presented as option.

14. The method of claim 1, wherein AC are assigned with CC such that;
existing algorithms for autocompletion of words are used;
multiple keystrokes ambiguity is minimal;
minimum ambiguity sequences having valid words in a given language for both sequence of consecutive Carrier characters and replacing corresponding consecutive AC letters; or
as subsidiary characters to keys with CC that is based on a prefix, assists in decoding the received sequence.

15. (canceled)

16. (canceled)

17. (canceled)

18. A system for usage of a keyboard interface with less number of keys than characters in a language, the system comprising:
a keyboard of a given language, wherein, characters of the given language are assigned to keys on the keyboard, wherein for at least one key: (i) a primary character is determined as a carrier character (CC) and one or more predefined characters are determined as accompanied characters (AC); (ii) one or more AC are assigned to the same key with one CC wherein each CC display characteristics is distinctive from the AC display characteristics;
display module for receiving a first sequence of keystrokes followed by a second sequence of keystrokes from one or more keys on the keyboard interface which relate to the same word;
input analysis module for checking the first sequence of keystrokes from the one or more keys to determine if it was received from keys that were keystroked consecutively more than one time and are associated with CC and associated with one or more AC, analyzing the one or more keystrokes in first the sequence that were typed on keys with CC and one or more AC to decode each sequence that was received from the same key to a valid sequence in the given language;
wherein said analyzing comprising the following steps:
identifying the amount of keystrokes in the received first sequence;
determining a first sequence of characters;
wherein when the first received sequence includes at least two consecutive CC decoded according to predefined rules, the predefined rules are calculated rules based on statistical analytics of the given language of words usage,
wherein a first sequence of characters is replaced to a second sequence of characters based on analysis of the received second sequence of keystrokes, according to the context of the first sequence in the word, and according to an algorithm of identifying and replacing any CC double appearance to the associated AC in the given language, and
wherein the assignment of the CC and AC on the keyboard interface is arranged to minimize options of multiple yielded characters or a series of characters or complete words ambiguity.

19. The system of claim 18 wherein the predefined rules are related to order of arrangement of the characters on the keyboard or are related to identified rules of the given language.

20. The system of claim 18, wherein at least one key is assigned with one character.

21. (canceled)

22. (canceled)

23. The method of claim 1 further comprising a keyboard construction module—for determining the association of the CCs characters to their ACs characters and the order of arrangement according to the following steps:
searching words with double appearance of same character in the database of words;
counting for each character in the language the number of words that were found;
selecting a predefined amount of characters with a number of words equal or lower to a predefined threshold;
defining the selected characters potential primary characters;
marking the primary characters as carrier characters;
assigning the CC to keys on the keyboard;
searching for each character that was not marked as CC, words that include the character;
counting for each character in the language the number of words that were found;
selecting a predefined amount of characters with a number of words equal or lower to a predefined threshold;
defining the selected characters with low frequency in words in the language as potential accompanied characters (AC);
marking the accompanied characters;
assigning the AC as subsidiary characters to keys with CC of first type; and
assigning characters that were not marked as AC or CC to keys with a single character.

24. (canceled)

25. The method of claim 23, wherein determining the sequence of characters to be at least one of: (i) prefix; (ii) infix; and (iii) suffix, of a word and wherein according to the determining a predefined rule is applied.

26. The system of claim 18, wherein a simulation of keystroking of a predefined amount of words in the language such as a public domain corpora of this language is performed to calculate and assign the chosen AC out of the potential ACs of claim 6 to the potential CCs of claim 6, such as the final assignments of the ACs characters to the CCs characters to yield minimal amount of legal words in the language that are ambiguous, Ambiguity of words means here that there exist in the language a legal word with a sequence of characters including a double appearance of the CC and another legal word that generated from concatenation of the same sequence before the double CC and after the double CC and the double CC itself is replaced by its associated AC.

27. (canceled)

28. The system of claim 18, wherein a predefined key on the keyboard enables selection of actions or enables selection of other keys.

29. The system of claim 18, wherein the assigning of the AC as subsidiary characters to keys with CC that is based on a prefix, assists in decoding the received sequence.

30. The system of claim 18, wherein:
AC are assigned with CC based on data related to frequency of usage of words in the language, where AC and CC appear, and in case of a collision between a sequence of CC and AC a common word with one of the sequences is presented to the user; or
AC are assigned with CC such that existing algorithms for autocompletion of words are used; or
multiple keystrokes ambiguity is minimal; or
AC are assigned with CC such that, minimum ambiguity sequences having valid words in a given language for both sequence of consecutive Carrier characters and replacing corresponding consecutive AC letters.

31. (canceled)

32. (canceled)

33. The system of claim 18, wherein sequence of keystrokes is entered in an equal pace.

34. (canceled)

35. The method of claim 1 wherein the selection between two types of CC on the keyboard is determined based user behavior or based user behavior including at least one of: duration of the keystroke, a gesture of the fingers, identifying different fingers on the keyboard interface, or a gesture captured by a camera.

36. (canceled)

37. The method of claim 1, wherein AC are assigned with CC based on data related to frequency of usage of words in the language, and in case of a collision where the change in one legal word which contains at least two successive keystrokes of the same CC letter, by replacing the two successive keystrokes with the respective AC results a second legal word, is presented the word which is most relevant to the type sentence.
